(19) United States
(12) Patent Application Publication
(10) Pub. No.: US 2010/0070544 A1
(43) Pub. Date: Mar. 18, 2010

(54) VIRTUAL BLOCK-LEVEL STORAGE OVER A FILE SYSTEM

(75) Inventors: Yadhu Nandh Gopalan, Issaquah, WA (US); Andrew Michael Rogers, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/209,358

(22) Filed: Sep. 12, 2008

(51) Int. Cl. G06F 12/00

(52) U.S. Cl. 707/822; 707/E17.01; 711/E12.002

(57) ABSTRACT

Embodiments of the invention create a virtualized storage device on a file system. Block-level storage units or clusters corresponding to the file system are defined for a storage volume associated with a computing device. Responsive to receipt of a block-level command (e.g., received via a universal serial bus), the computing device identifies a file system operation corresponding to the block-level command. The computing device performs the file system operation for the storage volume. Embodiments of the invention enable a mobile computing device to present the storage volume as a virtualized storage device to a host computing device for access while retaining control over the file system.

### BACKGROUND

Many protocols such as the universal serial bus (USB) mass storage protocol implement block-level input/output (I/O) to attach removable storage devices to computing devices. The block-level I/O reads and writes raw disk sectors unlike a file-level protocol such as the file transfer protocol (FTP). As such, the existing protocols are limited. For example, with the existing systems, the removable storage devices and the computing devices must share the same file system format such as the file allocation table (FAT) file system. Additionally, the removable storage device may be connected to only one computing device at a time.

The existing systems are not suitable for complex devices such as mobile telephones and personal digital assistants that desire to expose internal memory to a host device via USB. For example, both the operating system on the mobile telephone and the operating system on the host device cannot manage the memory simultaneously. Additionally, with the existing systems, the mobile telephone is limited to implementing a file system format common to most host devices, which may not be appropriate for the mobile telephone.

### SUMMARY

Embodiments of the invention create a virtualized storage device on a file system. Block-level storage units corresponding to the file system are defined for a storage volume associated with a computing device. Responsive to receipt of a block-level command, the computing device identifies a file system operation corresponding to the block-level command. The computing device performs the file system operation for the storage volume.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a virtual storage volume simulating a file system on a computing device.

FIG. 2 is an exemplary block diagram illustrating a computing device having computer-executable components for implementing aspects of the invention.

FIG. 3 is an exemplary flow chart illustrating the translation of block-level commands into file system operations.

FIG. 4 is an exemplary block diagram illustrating a mobile computing device mapping block-level commands received from a host computing device to file system operations.

FIG. 5 is an exemplary flow chart illustrating the definition of metadata corresponding to the files and directories of a file system.

Corresponding reference characters indicate corresponding parts throughout the drawings.

### DETAILED DESCRIPTION

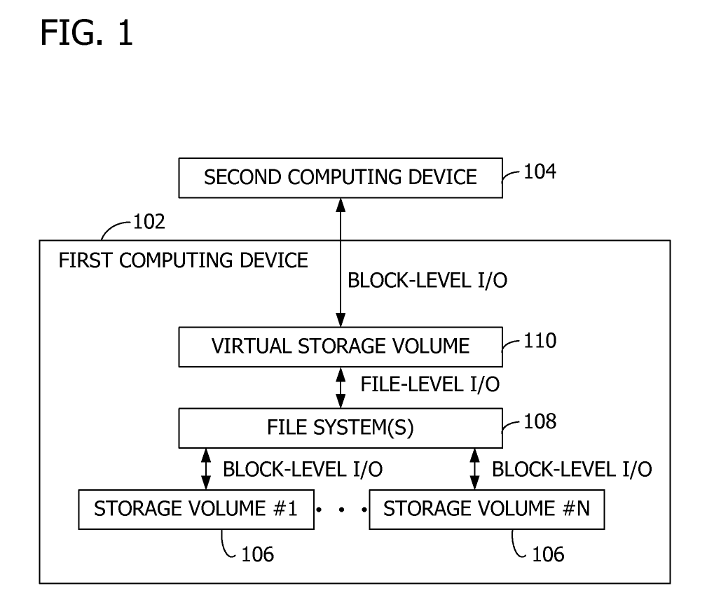

Embodiments of the invention provide a virtual storage volume 110 for a file system 108 on a first computing device 102 such as shown in FIG. 1. The first computing device 102 translates block-level input/output (I/O) commands received from a second computing device 104 into file-level operations. The file-level operations are performed against one or more storage volumes 106 associated with the first computing device 102, such as storage volume #1 through storage volume #N where N is a positive integer. In some embodiments (not shown), the first computing device 102 is a memory storage device, without a processor, such as a flash drive. In an embodiment, the block-level commands comprise commands composed of fixed size units that correspond to a minimum I/O resolution of the first computing device 102 (e.g., 512 bytes).

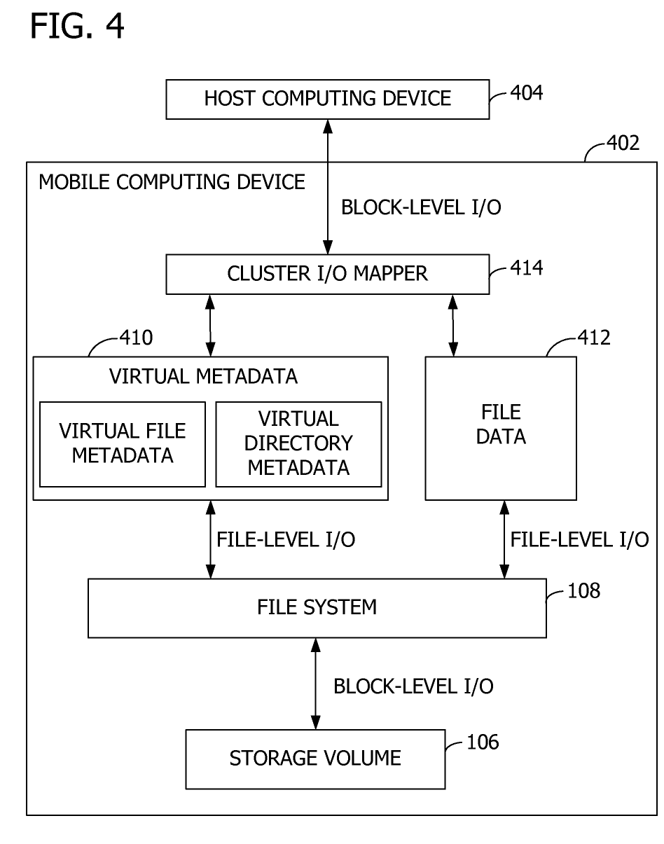

In some embodiments, the high-compatibility rate of common file systems such as the file allocation table (FAT) file system over a block-level protocol is leveraged by exposing a simulated FAT-formatted block device (e.g., the virtual storage volume 110). While some embodiments are described with reference to the FAT file system, universal serial bus (USB) mass storage protocol, or other specific file systems or protocols, other file systems and protocols are contemplated. Embodiments of the invention are operable with any file system 108 or block-level protocol or I/O mechanism. Further, while some embodiments of the invention are illustrated and described herein with reference to a mobile computing device such as a mobile computing device 402 (see FIG. 4), aspects of the invention are operable with any device (with or without a processor) that has memory associated therewith. For example, other devices include a flash drive, mobile telephone, laptop, personal digital assistant, portable music player, gaming console, watch, and camera.

Referring again to FIG. 1, the first computing device 102 communicates with the second computing device 104 via block-level I/O. In some embodiments (not shown), a network communicatively couples the first computing device 102 and the second computing device 104. The first computing device 102 includes one or more of the storage volumes 106 and one or more file systems 108. In an example, there is a single file system 108 managing one or more of the storage volumes 106. Alternatively or in addition, there may be a plurality of file systems 108 for managing the storage volumes 106. The virtual storage volume 110 communicates with the file system 108 via file-level I/O, and communicates with the second computing device 104 via block-level I/O.

The virtual storage volume 110 enables file sharing between the first computing device 102 and the second computing device 104 so that the file system 108 is accessible to both devices 102, 104 simultaneously. Further, by monitoring the incoming block-level I/O from the second computing device 104, the virtual storage volume 110 prevents the second computing device 104 from corrupting the data stored in the storage volumes 106. Additionally, because of the existence of the virtual storage volume 110, the second computing device 104 does not need to understand the format of the file system 108 of the first computing device 102. Aspects of the invention also enable the first computing device 102 to implement encryption for the file system 108 and storage volumes 106. In such an embodiment, the virtual storage volume 110 supports the encryption and decryption of data to and from the file system 108.

In an example, the first computing device 102 is the mobile computing device 402, the storage volumes 106 include internal flash and a removable media card, and the second computing device 104 comprises a host such as a laptop or desktop. In this example, the mobile computing device 402 may expose the internal flash and removable media card as a single virtual storage volume or as separate virtual storage volumes. Further to this example, the mobile computing device 402 receives the block-level commands as a small computer system interface (SCSI) command over a universal serial bus (USB). Yet further, both the mobile computing device 402 and the host are able to access the internal flash and the removable media card at the same time.

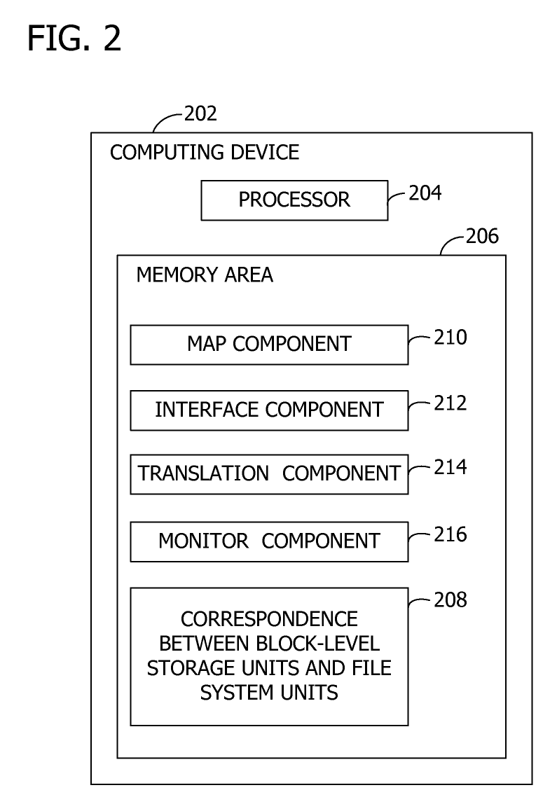

Referring next to FIG. 2, an exemplary block diagram illustrates a computing device 202 such as the first computing device 102 in FIG. 1 having computer-executable components for implementing aspects of the invention. The computing device 202 includes a processor 204 and a memory area 206. The memory area 206, or other computer-readable medium, stores a correspondence 208 between block-level storage units such as sectors or clusters and file system units such as files and directories.

The memory area 206 further stores computer-executable components including a map component 210, an interface component 212, a translation component 214, and a monitor component 216. While the memory area 206 is shown as a different element from the storage volumes 106 in FIG. 1, it is contemplated that the memory area 206 may be one or more of the storage volumes 106.

The map component 210 defines the block-level storage units corresponding to the file system 108 for the storage volume 106 associated with the computing device 202. For example, the map component 210 creates and exposes cluster chains corresponding to the file system units. The map component 210 further defines metadata describing the files and directories in the file system 108. In some embodiments, the map component 210 defines the block-level storage units corresponding to selected file system units only. The selected file system units may be chosen based on various criteria or explicit configuration input from a user. For example, the user may identify the particular files (e.g., a subset of all the files) and directories to be exposed to other devices via the virtual storage volume 110.

The interface component 212 receives a block-level command from, for example, a computing device such as the second computing device 104 in FIG. 1. The block-level command includes, for example, a read or write command to one of the files in the file system 108. The translation component 214 identifies a file system operation corresponding to the received block-level command based on the block-level storage units defined by the map component 210. The translation component 214 further provides the identified file system operation to the file system 108 for performance on the storage volume 106. Alternatively, the translation component 214 performs the identified file system operation. The monitor component 216 maintains the metadata defined by the map component 210 responsive to the block-level command received by the interface component 212. For example, the monitor component 216 updates the metadata upon receipt of a block-level command to create a new file, delete a file, add a directory, or delete a directory.

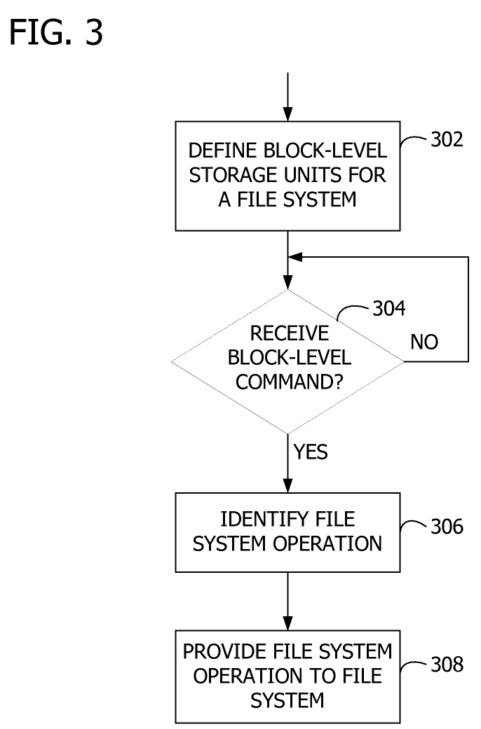

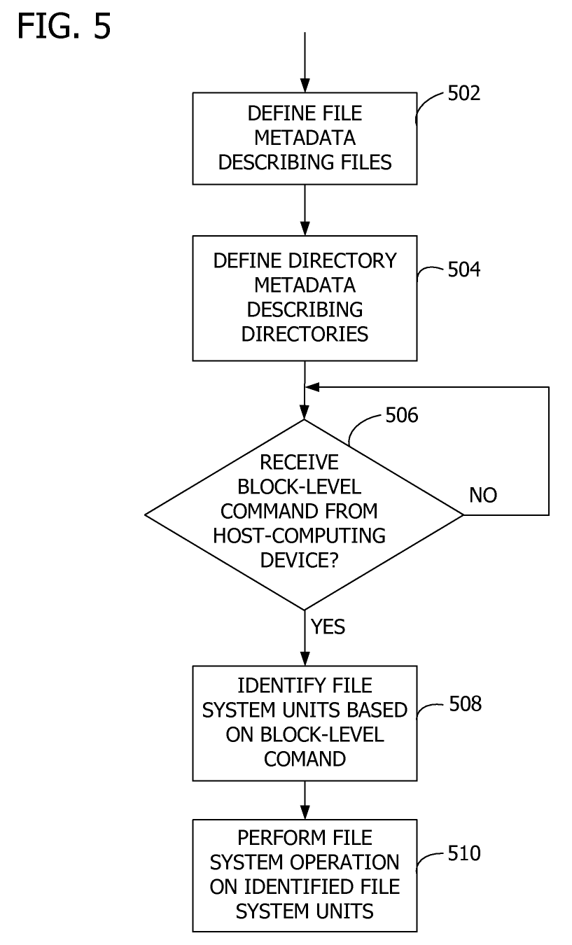

In an embodiment, the processor 204 is transformed into a special purpose microprocessor by executing computer-executable instructions or by otherwise being programmed. For example, the processor 204 executes computer-executable instructions for performing the operations illustrated in FIG. 3 and FIG. 5. In the embodiment of FIG. 3, an exemplary flow chart illustrates translation of block-level commands into file system operations. At 302, block-level storage units corresponding to the file system 108 for the storage volume 106 are defined. In embodiments in which the second computing device 104 is compatible with a FAT file system, a FAT is defined to present the block-level storage units for each of the files to the second computing device 104. The storage volume 106 is associated with the first computing device 102.

In other embodiments (not shown), the block-level storage units correspond to only a subset of the file system units associated with the file system 108. For example, the subset may be identified explicitly by the user as configuration input, or the subset may be programmatically identified based on pre-defined criteria such as the location of the files within the file system 108 (e.g., in a protected directory such as a directory containing operating system files).

If block-level commands are received from the second computing device 104 at 304, the file system operation corresponding to the received block-level command is identified at 306 based on the defined block-level storage units. The identified file system operation is provided to the file system 108 at 308 for execution on the storage volume 106 of the first computing device 102.

Referring next to FIG. 4, an exemplary block diagram illustrates the mobile computing device 402 mapping block-level commands received from the host computing device 404 to file system operations. The mobile computing device 402 has access the storage volume 106, either internally or externally, removable or non-removable. The file system 108 associated with the storage volume 106 communicates with the storage volume 106 via block-level I/O. In an embodiment, the mobile computing device 402 selectively shares certain files and directories across different storage volumes 106 (such as internal flash and a removable media card) as the single virtual storage volume 110.

In the example of FIG. 4, the virtual storage volume 110 is represented by a cluster I/O mapper 414 tracking which virtual clusters exposed to the host computing device 404 correspond to each file in the file system 108. As the host computing device 404 reads or writes a cluster, the cluster I/O mapper 414 redirects the operation to the proper position in the file system 108. For example, if the cluster is mapped to a virtual directory, the cluster I/O mapper 414 returns or modifies the appropriate virtual directory data. To this end, the cluster I/O mapper 414 separates virtual metadata 410 from file data 412. The virtual metadata 410 includes, for example, virtual file metadata and virtual directory metadata.

The cluster I/O mapper 414 receives incoming block-level I/O from the host computing device 404, and separates the received I/O into the virtual metadata 410 and the file data 412. For example, if the received I/O corresponds to a command to create a new file, the cluster I/O mapper 414 updates the virtual file metadata, translates the command to a file-level operation, and provides the file-level operation to the file system 108. In a similar example, if the received I/O corresponds to a command to create a new directory, the cluster I/O mapper 414 updates the virtual directory metadata, translates the command to a file-level operation, and provides the file-level operation to the file system 108. As another example, if the received I/O corresponds to file data 412 (or payload data), the cluster I/O mapper 414 maps the received I/O to file-level I/O and provides the file-level I/O to the file system 108.

In an embodiment, the cluster I/O mapper 414 is a FAT virtualization layer that describes a set of files to be shared with the host computing device 404 and manages the mapping of names, sizes, and data of files and directories to those stored on the mobile computing device 402 independent of the file system format internal to the mobile computing device 402. The FAT virtualization layer simulates, emulates, or otherwise presents cluster chains corresponding to one or more files in the file system 108. If the host computing device 404 makes modifications to the FAT, the changes are communicated to the cluster I/O mapper 414. The cluster chains of the virtual FAT are mapped to the actual file contents on the storage device. The cluster chains are allocated in random access memory (RAM) or separate files. The size of the virtual FAT, and the storage volume 106 exposed, depend on the quantity of files being shared and the amount of free space available for the host computing device 404 to create new files. In some embodiments, the virtual FAT data is written to disk or saved as a memory-mapped file to reduce RAM usage.

In the FAT virtualization layer example, virtual directories include specially allocated cluster chains containing FAT directory entries generated by the mobile computing device 402. Each file exposed to the host computing device 404 is given an entry in one of the virtualized directories. If the host computing device 404 creates new files, those changes are translated to new file creation on the mobile computing device 402. Depending at least on the complexity of the system, the mobile computing device 402 may expose a single virtual directory containing all files to be shared, or the mobile computing device 402 may map files to multiple virtual directories. Virtual directory data may be allocated in RAM for higher performance or written to disk to reduce RAM usage.

Write operations performed by the host computing device 404 are monitored and interpreted by the FAT virtualization layer so the write operations may be translated to file-level operations to be performed on the mobile computing device 402. For example, the virtual FAT is monitored for new allocations: the host computing device 404 may create or delete new files and directories, extend or truncate existing files and directories, and/or potentially re-map existing cluster chains to new clusters. Further, each virtual directory is monitored for file name, timestamp, and attribute changes as well as file creation and deletion.

Referring next to FIG. 5, an exemplary flow chart illustrates the definition of metadata corresponding to the files and directories of a file system such as file system 108. At 502, file metadata describing the files in the file system 108 is defined. At 504, directory metadata describing the directories in the file system 108 is defined. If a block-level command directed to block-level storage units is received from the host computing device 404 at 506, the file system units corresponding to the received block-level storage units are identified at 508 based on the known correspondence 208 between the block-level storage units and the file system units. At 510, a file system operation based on the defined file metadata and the defined directory metadata is performed on the identified file system units.

### Exemplary Operating Environment

A computer or computing device such as described herein has one or more processors or processing units, system memory, and some form of computer readable media. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

The embodiments illustrated and described herein as well as embodiments not specifically described herein but within the scope of aspects of the invention constitute exemplary means for virtualizing the block-level storage volume 106 on top of the file system 108 on the mobile computing device 402, and exemplary means for simulating cluster chains for the file system units.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for virtualizing a storage volume on a file system for a mobile computing device, said system comprising:
a memory area on a mobile computing device for storing a correspondence between block-level storage units and file system units for a file system on the mobile computing device, said file system units including one or more files and one or more directories; and
a processor programmed to:
define file metadata describing the files in the file system;
define directory metadata describing the directories in the file system;
receive a block-level command from a host computing device, said received block-level command directed to block-level storage units;
identify the file system units corresponding to the received block-level storage units based on the correspondence stored in the memory area; and
performing a file system operation on the identified file system units based on the defined file metadata and the defined directory metadata.

2. The system of claim 1, wherein the memory area stores the correspondence as a mapping between clusters and the file system units.

3. The system of claim 1, further comprising means for virtualizing a block-level storage volume on top of a file system on the mobile computing device.

4. The system of claim 1, further comprising means for simulating cluster chains for the file system units.

5. A method comprising:
defining block-level storage units corresponding to a file system for a storage volume associated with a first computing device;
receiving a block-level command from a second computing device;
identifying a file system operation corresponding to the received block-level command based on the defined block-level storage units; and
providing the identified file system operation to the file system for execution on the storage volume of the first computing device.

6. The method of claim 5, wherein defining the block-level storage units comprises defining clusters corresponding to the file system.

7. The method of claim 5, wherein defining the block-level storage units comprises defining a mapping between the block-level storage units and one or more file system components, said file system components comprising one or more of the following: a file and a directory.

8. The method of claim 5, wherein defining the block-level storage units comprises defining one or more block-level clusters corresponding to the file system.

9. The method of claim 5, wherein the file system comprises one or more files, and wherein defining the block-level storage units comprises defining a file allocation table to present the block-level storage units for each of the files to the second computing device.

10. The method of claim 5, wherein defining the block-level storage units comprises defining cluster chains corresponding to directories in the file system.

11. The method of claim 5, wherein the file system comprises file system units, further comprising receiving configuration input from a user, said configuration input identifying a subset of the file system units, and wherein defining the block-level storage units comprises defining block-level units for only the subset of the file system units.

12. The method of claim 5, wherein a plurality of storage volumes are associated with the first computing device, and wherein defining the block-level storage units comprises defining the block-level storage units for the plurality of storage volumes as a single virtual storage volume.

13. The method of claim 5, wherein receiving the block-level command comprises receiving the block-level command as a small computer system interface (SCSI) command over a universal serial bus (USB).

14. The method of claim 5, further comprising presenting the defined block-level storage units to the second computing device as a virtual storage volume.

15. One or more computer-readable media storing computer-executable components, said components comprising:
a map component for defining block-level storage units corresponding to a file system for a storage volume associated with a first computing device, said map component further defining metadata describing the file system;
an interface component for receiving a block-level command from a second computing device;
a translation component for identifying a file system operation corresponding to the received block-level command based on the defined block-level storage units, said translation component further providing the identified file system operation to the file system for performance on the storage volume; and
a monitor component for maintaining the metadata defined by the map component responsive to the block-level command received by the interface component.

16. The computer-readable media of claim 15, wherein the map component defines the block-level storage units corresponding to a plurality of file systems associated with the computing device.

17. The computer-readable media of claim 15, wherein the map component defines the block-level storage units corresponding to a plurality of storage volumes associated with the computing device.

18. The computer-readable media of claim 15, wherein the file system comprises a plurality of files, and wherein the map component defines the block-level storage units corresponding to a subset of the plurality of files.

19. The computer-readable media of claim 15, wherein the map component defines the block-level storage units based on configuration input from a user.

20. The computer-readable media of claim 15, wherein the map component allocates clusters corresponding to the file system.
